(19) United States
(12) Patent Application Publication
(10) Pub. No.: US 2005/0275195 A1
(43) Pub. Date: Dec. 15, 2005

(54) Foldable cart

(76) Inventors: Martha R. Matula, Loveland, CO (US); Donald G. Matula, Loveland, CO (US)

Correspondence Address: Paul M. Thompson;Cochran Freund & Young LLC, Suite 201, 2026 Caribou Drive, Fort Collins, CO, 80525, US

(21) Appl. No.: 11/148,716

(22) Filed: Jun. 8, 2005

Related U.S. Application Data
(60) Provisional application No. 60/579,063, filed on Jun. 10, 2004.

(51) Int. Cl. B62B 3/02

(52) U.S. Cl. 280/651

(57) ABSTRACT

A folding cart is disclosed, wherein the cart and its frame can be folded and unfolded by, respectively, pushing downward on a handle assembly after activating an actuator on the handle assembly for disengaging frame members, and lifting upward on the handle assembly to lock the frame members together. The cart may include various storage compartments and attachments, including: cup holders, cane holders, toy compartments, foldable chair compartments, compartments for small electronic devices, etc.

### CROSS REFERENCE TO RELATED APPLICATIONS

This application is based upon and claims the benefit of U.S. provisional application No. 60/579,063, entitled “Foldable Cart and Method for Operating Same”, filed Jun. 10, 2004, the entire disclosure of which is hereby specifically incorporated by reference for all that it discloses and teaches.

### BACKGROUND OF THE INVENTION

1. Field of the Invention

The present invention relates generally to carrier vehicles and more specifically to a cart with a rigid foldable frame supporting a non-rigid compartment.

2. Description of the Background

Various wheeled carts have been developed that are capable of being folded into a smaller size than their unfolded configuration. However, such carts are generally not designed for maneuverability and quick and easy folding and unfolding. Additionally, such prior art carts do not provide conveniences for users such as various readily available storage compartments and/or accessories for hanging coats, attaching canes, carrying small electronics such as cell phones or laptop computers. Moreover, such carts are generally designed for smooth, hard surfaces and accordingly, may have difficulty in being maneuvered over rough or uneven surfaces.

### SUMMARY OF THE INVENTION

An embodiment of the present invention may comprise a foldable cart, comprising: a foldable frame, including a first frame portion and a second frame portion that fold together; a handle assembly connected to the first frame portion, wherein the handle assembly includes an actuator for folding the frame from an extended configuration to a folded configuration, wherein the actuator includes: (a) a safety locking component that must be unlocked prior to activating the actuator to fold the frame, and (b) a separation assembly for remotely separating the first frame portions and the second frame portion; a flexible material attached to the frame for expanding at least one storage compartment when the frame is in the extended configuration, and for folding substantially within the dimensions of the frame when the frame is in the folded configuration; a plurality of wheel assemblies attached to the frame and for supporting the cart when the frame is in the extended configuration, the wheel assemblies including: a first wheel assembly positioned at substantially a front of the cart when the frame is in the extended configuration, and a second wheel assembly positioned at substantially a rear of the cart when the frame is in the extended configuration; wherein when the frame is actuated from the extended configuration to the folded configuration, the first wheel assembly and the second wheel assembly fold toward one another.

An embodiment of the present invention may also comprise a foldable cart, comprising: a foldable frame, including a first frame portion and a second frame portion that fold together; a handle assembly connected to the first frame portion, wherein the handle assembly includes an actuator for folding the frame from an extended configuration to a folded configuration, wherein the actuator includes a safety locking component that must be unlocked prior to activating the actuator to fold the frame, the frame that forms a plurality of attachment points that support a non-rigid material attached to the frame for expanding at least one storage compartment when the frame is in the extended configuration, and for folding substantially within the dimensions of the frame when the frame is in the folded configuration; a plurality of wheel assemblies attached to the frame and for supporting the cart when the frame is in the extended configuration, the wheel assemblies including: a first wheel assembly positioned at substantially a front of the cart when the frame is in the extended configuration, and a second wheel assembly positioned at substantially a rear of the cart when the frame is in the extended configuration; wherein when the frame is actuated from the extended configuration to the folded configuration, the first wheel assembly and the second wheel assembly fold toward one another.

### BRIEF DESCRIPTION OF THE DRAWINGS

In the drawings,

FIG. 1 shows a perspective view of an embodiment of a folding cart, wherein the cart is fully-extended

FIG. 2 shows a side view of an embodiment of a folding cart.

FIG. 3 shows a rear perspective view of an embodiment of a folding cart.

FIG. 4 shows an embodiment of a folding cart in a fully-folded configuration.

FIG. 5 shows a rear view of an embodiment of a folding cart, and in particular, the handle assembly.

FIG. 6 shows another view of the handle assembly together with the accessory attachment having cup holders and at least one container for small items such as food, spare change or small electronics. Additionally, this figure shows the coat and garment hanger attachment accessory in a folded or stored configuration; however, the cart is not folded.

FIG. 7 shows another view of the handle assembly, the accessory attachment, and a rear interior wall of a primary storage compartment, wherein this rear wall includes a secondary storage compartment.

FIG. 8 shows the foldable frame in an embodiment of a folding cart, wherein the frame is in its fully-extended configuration.

FIG. 9 shows the frame in its fully-folded configuration.

FIG. 10 shows a detailed view of the primary frame connector together with a pivotally matable lock for both locking and unlocking the frame, and more particularly, the frame arms and the front frame legs.

FIG. 11 shows a further view of the connectors together with their corresponding spring biased locks, wherein these pairs of components are disengaged from one another so that the frame and the cart can be provided in its fully-folded configuration.

FIG. 12 shows another view of the frame in a fully-folded configuration wherein the alignment of the front and rear wheels and their corresponding assemblies are also shown.

FIG. 13 shows a more detailed view of a front wheel assembly.

FIG. 14 shows a more detailed view of various components attached to or contacting a rear wheel. In particular, this figure shows the components of a rear wheel brake assembly having a foot pedal operatively connected to a shaft for moving the shaft between: (i) a wheel position wherein the shaft is between two consecutive pedals, and (ii) an unlocked position wherein the shaft is shown as in the present figure.

FIG. 15 shows a hand brake for an embodiment of a folding cart.

FIG. 16 shows how an embodiment of a folding cart that can be pulled substantially in the same manner as wheeled luggage is pulled.

### DETAILED DESCRIPTION OF THE INVENTION

While this invention is susceptible to embodiment in many different forms, there is shown in the drawings and will be described herein in detail specific embodiments thereof with the understanding that the present disclosure is to be considered as an exemplification of the principles of the invention and is not to be limited to the specific embodiments described.

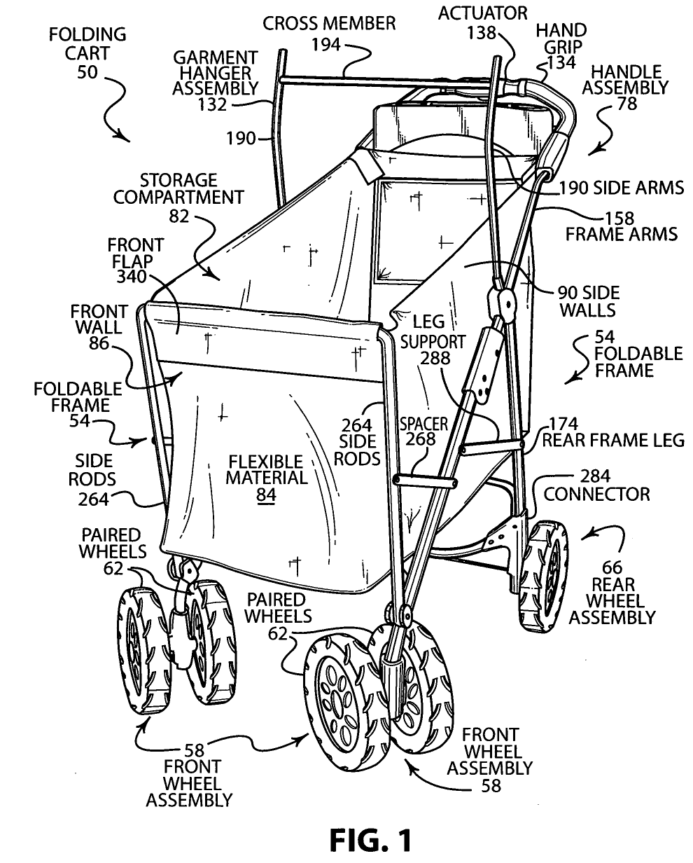

FIGS. 1 through 3 show various perspectives of a folding cart wherein various compartments and attachments for storing in and/or hanging items thereon. Additionally, when the folding cart is in an extended or unfolded configuration, some embodiments of the cart may assist the user in walking or standing. Moreover, the handle assembly provides full control for manipulating the cart into its extended configuration, and for unlocking the cart frame so that the cart may be fully-folded. In particular, all that is required of the user to fold the cart is to press frame unlock button, then rotate an actuator on the cart handle (by a simple twist of the users wrist), and move the handle towards the rear wheels of the cart. Similarly, to unfold the cart, the user need only unlatch the folded cart frame, so that it is no longer secured in the folded configuration, and pull the handle assembly away from the rear wheels. Thus, the user can fold or unfold the cart with substantially one hand.

In its fully-folded configuration, the disclosed cart may be pulled using a strap allowing the cart to be rolled on only its rear wheels and pulled by a user in much the same fashion that wheeled luggage is pulled. Thus, the more compact folded configuration of the cart may be readily pulled through crowded areas such as an airport. Various braking mechanisms (hand brakes and/or foot brakes) may be provided so that embodiments of the cart can be prevented from both moving from a stationary position, as well as readily controlled when the cart is being maneuvered. The main or primary compartments in the cart are provided by a strong flexible material that both readily folds within the dimensions of the folded cart frame, as well as readily extends when the cart is unfolded for providing one or more storage compartments.

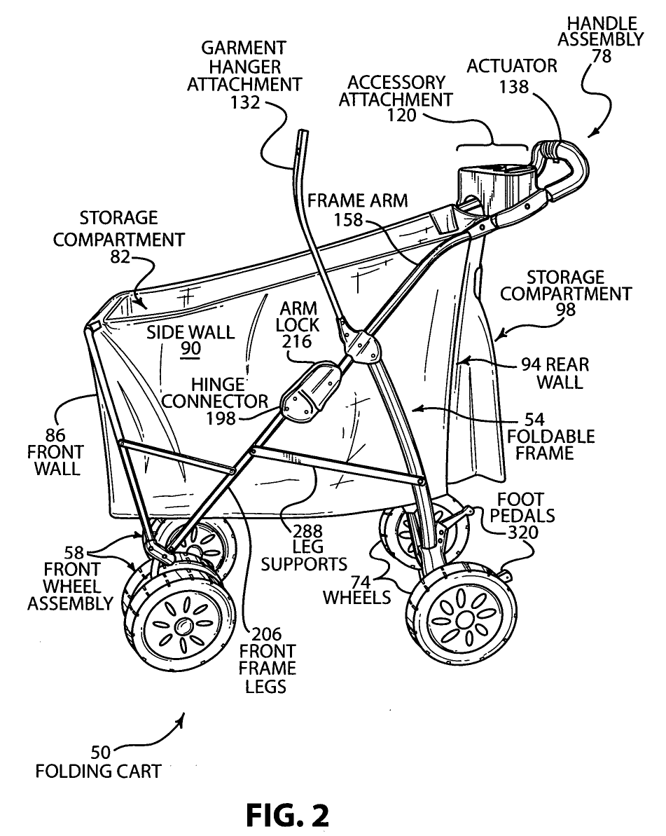

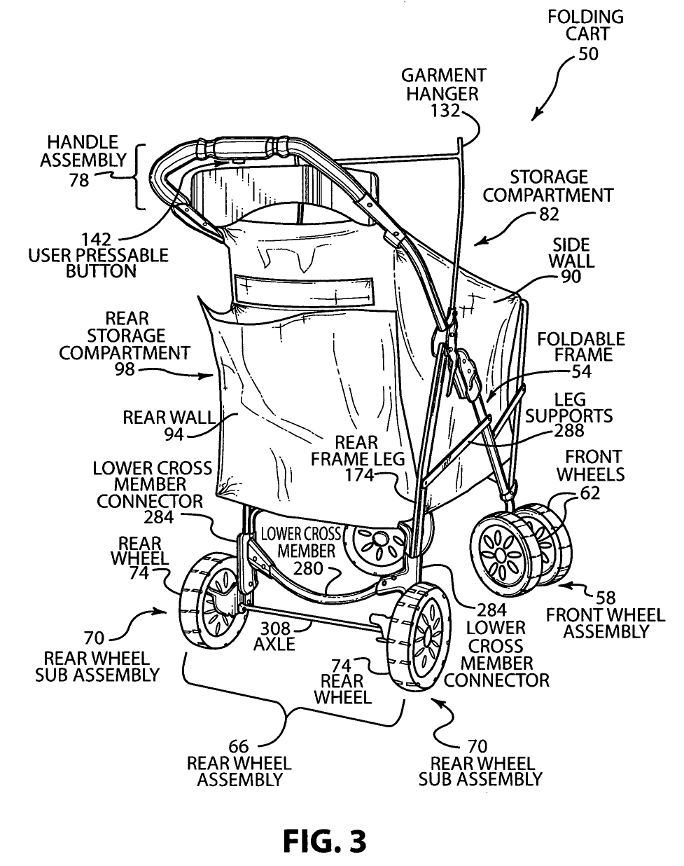

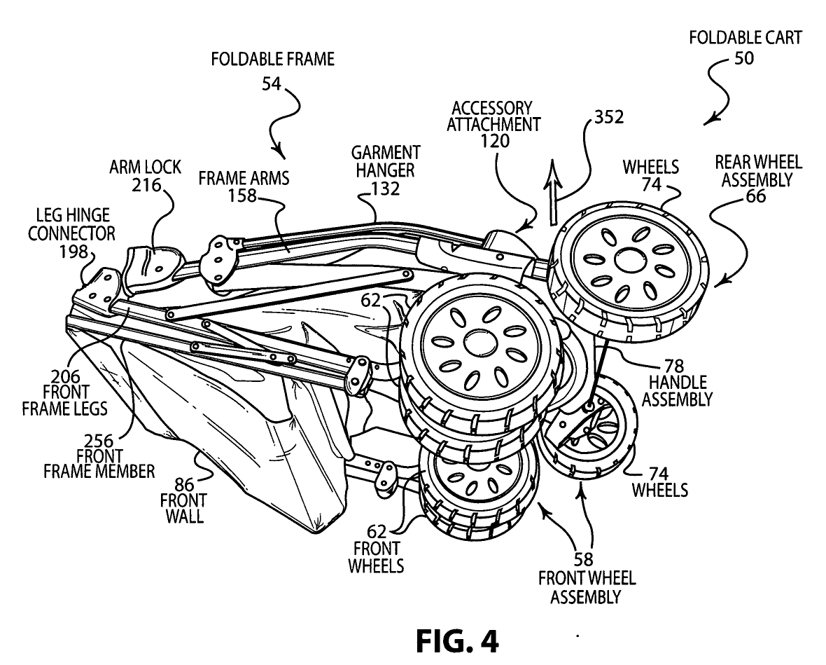

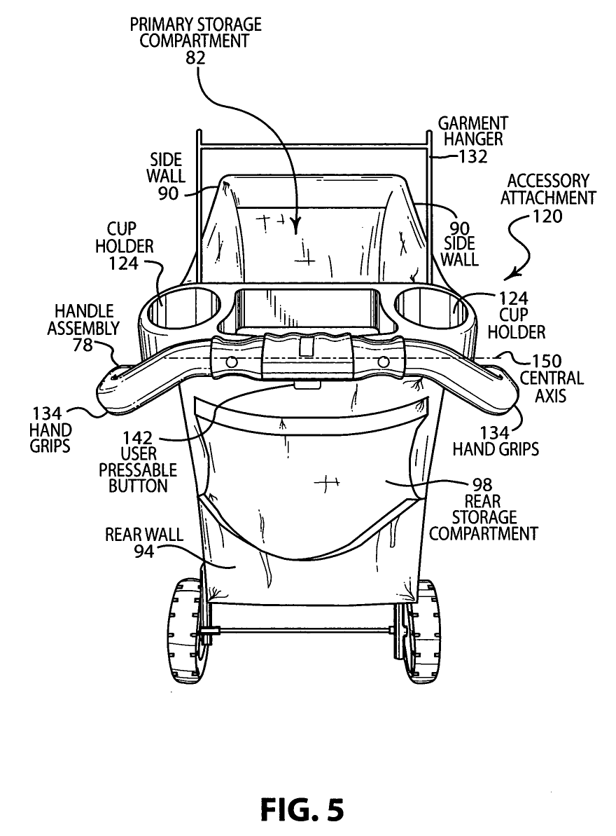

FIGS. 1 through 3 show various perspectives of an embodiment of the folding cart 50, wherein the cart is in a fully-unfolded or extended configuration operable for storing various items while being wheeled about by a user. The folding cart 50 of FIGS. 1 through 3 includes at least the following high level assemblies and components:
(a) a folding frame 54 to which substantially all other components of the cart 50 are operably connected. In particular, the frame 54 provides the structural features of the cart that allow the cart to be fully-extended as shown in FIGS. 1-3, or fully-folded as shown in FIG. 4;
(b) two front wheel assemblies 58 pivotally attached to the frame 54 so that the paired wheels 62 of each front wheel assembly 58 allow the cart 50 to be easily steered in substantially any direction desired by a user;
(c) a rear wheel assembly 66 that includes two rear wheel subassemblies 70 having corresponding wheels 74 for movably supporting the cart 50 (together with the front wheel assemblies 58);
(d) a handle assembly 78 shown in FIGS. 5-7, wherein the handle assembly is the contact portion between the user and the cart 50 and is used for moving and maneuvering, as well as providing the user with an actuator for unlocking the frame 54 from its extended position so that it can then be folded into the configuration of FIG. 4;
(e) one or more primary storage compartments 82 collectively identified by the label 82 (e.g., FIGS. 1-3), wherein the primary storage compartments 82 may expand to fill the volume substantially over the footprint defined by the wheels 62 and 74, and having a depth just above the wheel assemblies 58 and 70 to the upper cross member portions of the frame 54 as will be discussed further herein below. Note that in the embodiment of the cart 50 shown in the figures, there is a single primary storage compartment 82 made of a foldable, preferably strong, substantially non-tearable fabric or non-rigid material 84 such as nylon, canvas, vinyl, etc.;
(f) one or more secondary storage areas, generally attached to one of the foldable exterior walls of the primary storage compartment(s) 82, such exterior walls being identified as follows: a front wall 86 (FIG. 1), two side walls 90 (e.g., FIG. 5), and a rear wall 94 (e.g., FIGS. 2 and 3). Note that in the embodiment of the foldable cart 50 shown in the figures, such a secondary storage area 98 is provided on the rear wall 94, wherein this storage area 98 provides easy access for larger items (e.g., a purse, briefcase, or attache) by a user pushing the cart 50; and
(g) one or more accessory attachments for providing a cart user with storage and/or attachment devices that have been generally customized for ease of use in retaining specific items such as a drink, an umbrella, a cane, food being consumed while the user is pushing the cart 50, baby bottles, prescription drugs, small electronic devices (cell phone, portable CD player, etc.), spare oxygen tanks or the like. In the embodiment of the cart 50 shown in the figures, two such accessory attachments are shown. They are: an accessory attachment 120 adjacent to the handle assembly 78, having cup holders 124 and small item container 128 for providing the user with storage for items such as food being eaten while pushing the cart 50. Additionally, a second accessory attachment 132 is shown (FIG. 5), wherein this attachment allows a user to hang a coat and/or other garments provided on hangers as will be further described below.

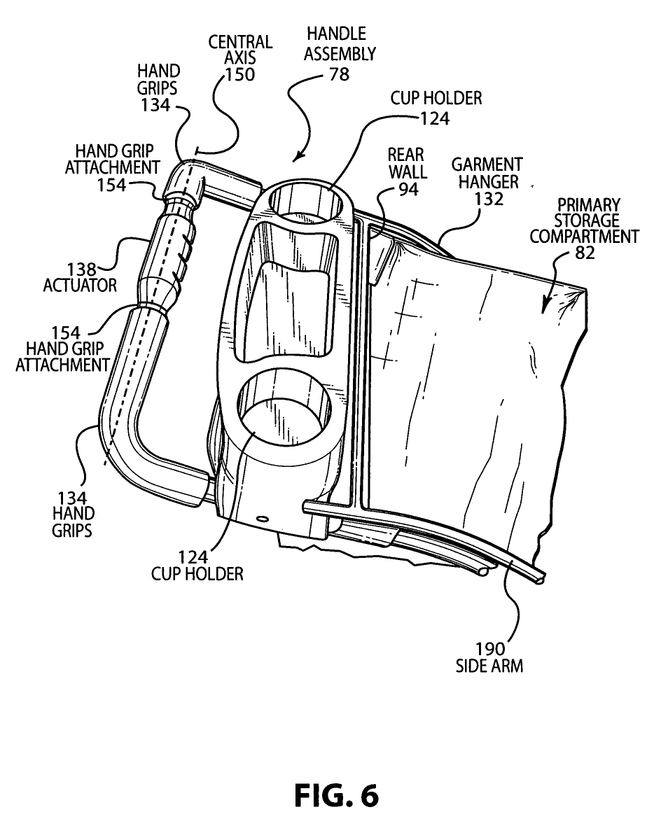

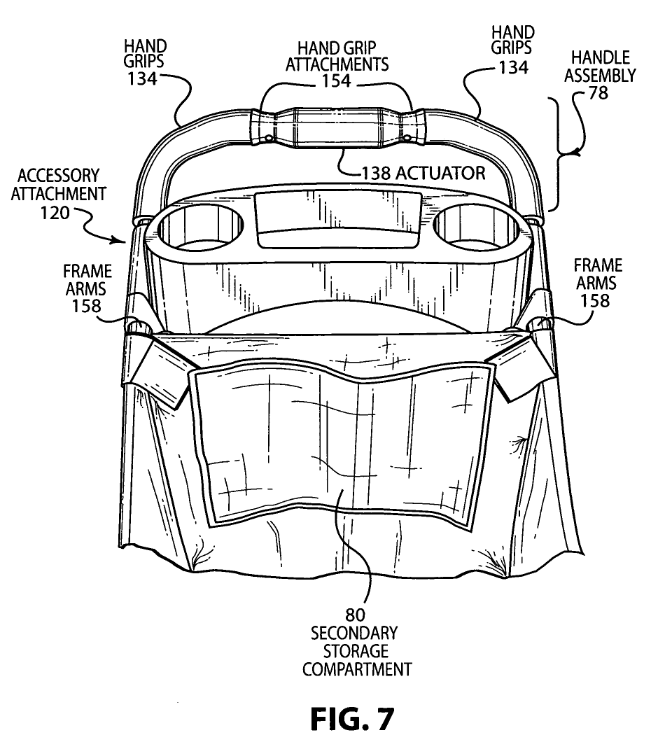

Describing the handle assembly 78 in more detail, reference is made to FIGS. 5 through 7. In particular, the handle assembly 78 extends across the width of the cart 50 at its rear. The generally L-shaped hand grips 134 are preferably covered with a soft or elastomeric material that both insulates a user's hands from heat and cold while allowing the user to grip the handle assembly comfortably and securely. Between the pair of hand grips 134 is a hand operated actuator 138 (e.g., FIG. 5) for unlocking the frame 54 so that the cart 50 can be folded into the configuration of FIG. 4. In particular, the actuator 138 includes a user pressable button 142 (FIG. 5) for disengaging a locking member (not shown) within a rotatable ergonomically contoured cylinder 146, wherein by pressing the button and rotating the cylinder generally about its central axis 150 (FIGS. 5 and 6) the cart 50 will readily collapse into its folded configuration of FIG. 4. Note that such rotation of the cylinder 146 releases hinged locking members of the frame 54 so that the cart 50 can easily be folded by the user. As shown in FIG. 7, the contoured cylinder 146 is sandwiched between a pair of hand grip attachments 154 that secure the actuator 138 to each of the hand grips 134.

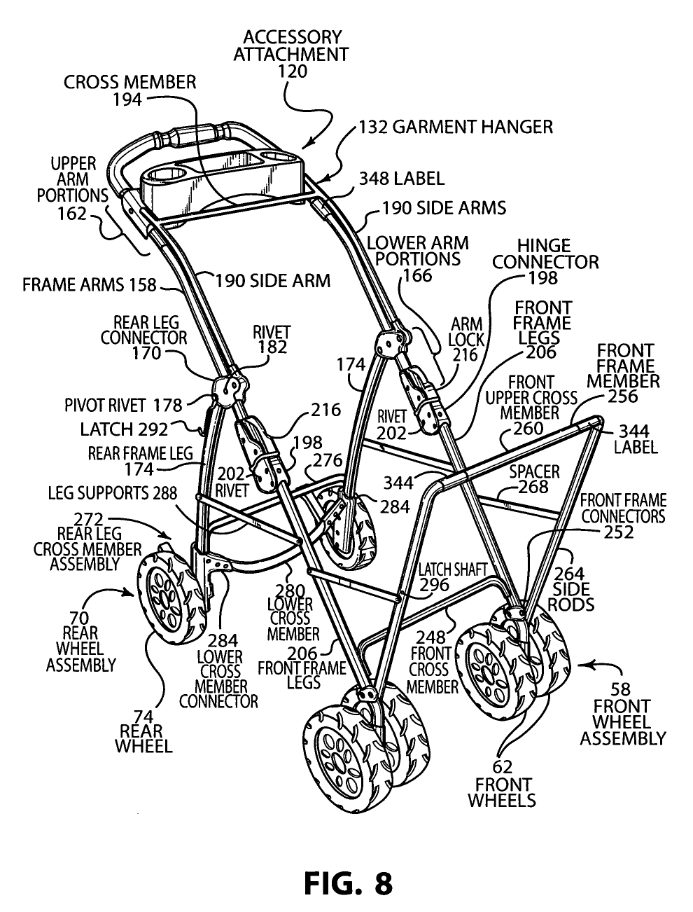

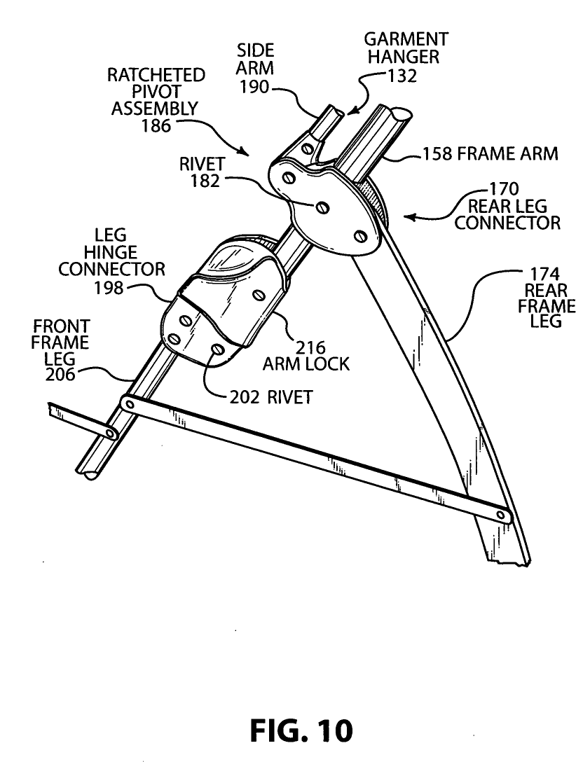

FIGS. 8 through 10 show the frame of the cart 50 without the primary storage compartment(s) 82 attached thereto. The frame 54 includes a pair of parallel curved frame arms 158, each having: (a) an upper arm portion 162 adjacent, and connecting to, one of the hand grips 134, and (b) a lower arm portion 166 that provides for the attachment of the frame arm 158 to other portions of the frame 54. In particular, each of the lower arm portions 166 extends through a rear leg connector 170 which is pivotally connected by pivot rivet 178 to a corresponding rear frame leg 174. Note that the rear leg connector 170 is fixed in its position on the frame arm 158 by a fastener (e.g., rivet 182 FIG. 10) which extends through both its corresponding rear leg connector, and corresponding arm 158. Integral with the rear leg connector 170, is a ratcheted pivot assembly 186 (e.g., FIG. 10) that connects the garment hanger accessory 132 to the frame arm 158 in a manner such that the attachment 132 can be pivoted into at least two secure or semi-locking positions. One such position is a retracted position shown in FIG. 8, whereby the side arms 190 of the attachment 132 are adjacent and substantially parallel to the frame arms 158, and the cross member 194 of the attachment 132 is substantially adjacent the accessory attachment 120. Alternatively, the ratcheted pivot assembly 186 allows a cart user to forcibly pivot the garment accessory attachment 132 into semi-locked extended position such as the position shown in FIGS. 1 through 3. Note that it is in this extended position that the garment hanging attachment 132 is particularly useful as a support, e.g., for a user's coat which can be hung or folded over the attachment 132 for ease of access without wrinkling, and additionally for purchased clothing on hangers which may be hung on the cross member 194.

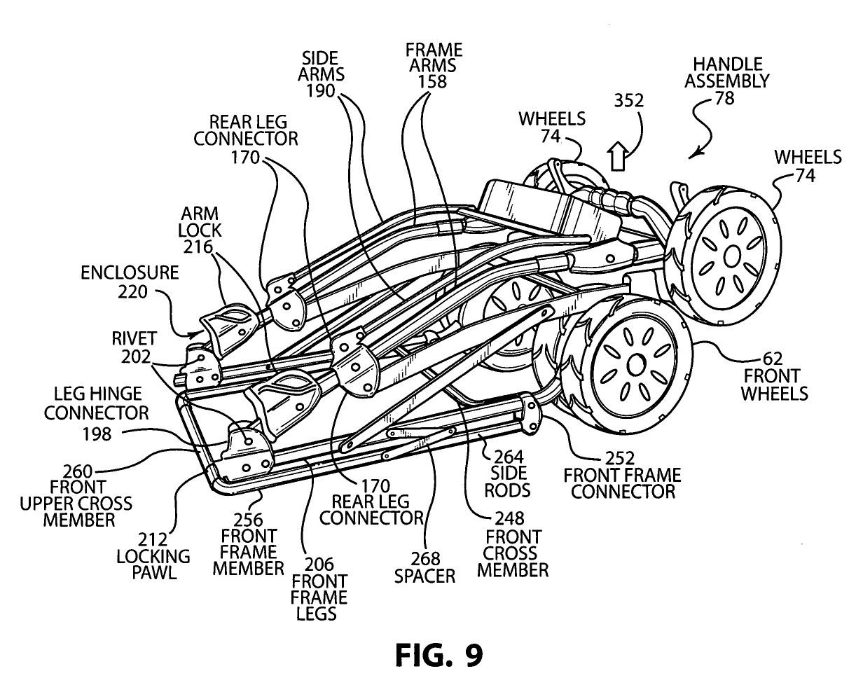

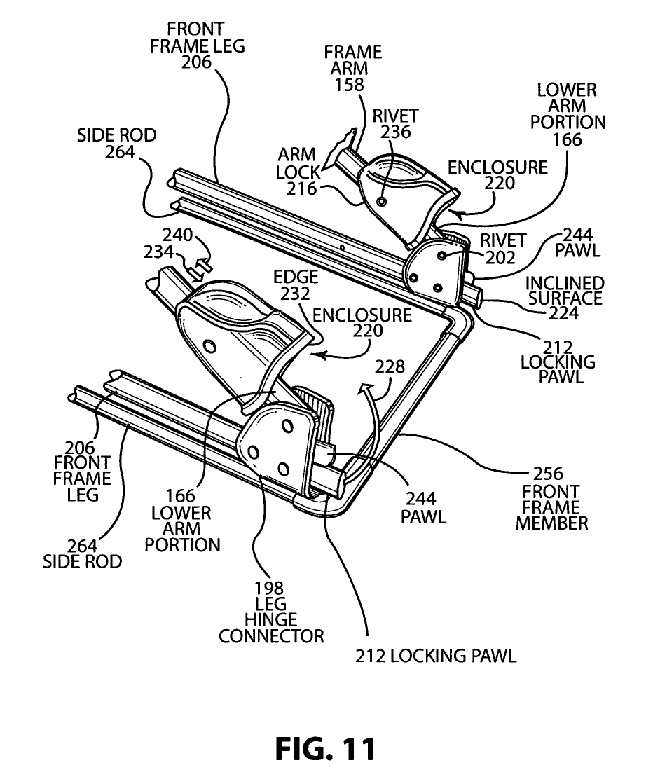

Referring again to the lower arm portions 166, each of these portions terminate in, and is securely attached to, an arm/leg hinge connector 198 (best shown in FIG. 10). In particular, each of the frame arms 158 is pivotally secured to a corresponding one of the connectors 198 (via pivot rivet 202) so that each of these arms can pivot between: (a) an extended position (as shown in FIGS. 2, 8 and 10), wherein each of the frame arms 158 is generally parallel to a corresponding front frame leg 206, and (b) a folded position as shown in FIG. 9, wherein the frame arms 158 and their corresponding frame legs 206 are acutely angled to one another. Each hinge connector 198 also includes a locking pawl 212 (best shown in FIG. 11). Each locking pawl 212 functions in combination with a corresponding spring biased arm lock 216 to lock a corresponding pair of one of the frame arms 158 and one of the frame legs 206 together in their substantially parallel orientations shown in FIGS. 2,8 and 10. More precisely, the spring biased arm lock 216 has formed therein a pawl receiving enclosure 220 (FIG. 11), wherein when the frame 54 unfolds, an inclined end surface 224 of the pawl 212 pivotally rotates according to arrow 228 so that the surface 224 contacts the edge 232 of the spring biased arm lock 216. Thus, since the arm lock 216 is biased (in the direction of arrow 234) by a tension spring (not shown) that resides within the lower arm portion 166 between the pivot rivet 202 and the slidable arm lock securing rivet 236, as the inclined surface 224 contacts the edge 232 during the rotation according to arrow 228, the surface 224 forces the arm lock 216 to slide along the length of the frame arm 158 in the direction of arrow 240 until the pawl 212 disengages the edge 232 and enters the enclosure 220. Accordingly, once the pawl 212 enters the enclosure 220, the bias of the tension spring in the direction of arrow 234 results in securing the pawl 212 in the enclosure 220. Moreover, note that for greater locking security, a second pawl 244 is also provided for entering a second mating enclosure (not shown) within the arm lock 216.

Actuator 138 of the handle assembly includes a rotatable ergonomically-contoured cylinder 146, wherein the rotatable cylinder can be hand rotated to disengage various frame members so that the frame 54 can fold into the configuration of FIG. 9. Within the actuator 138, is a mechanism for converting the rotational motion of the cylinder 146 into a linear motion of pulling upon a pair of cables (not shown), wherein each cable extends from the actuator 138 through one of the sides of the handle assembly 78 and also through the corresponding attached frame arm 158 such that the opposite end of the cable connects to the slidable arm lock securing rivet 236. Thus, user rotation of the cylinder 146 results in the arm locks 216 simultaneously moving in the direction of arrow 240, thereby allowing the pawls 212 and 244 to disengage from their corresponding arm locks 216 so that a user may then pivot the frame arms 158 relative to the legs 206 for attaining the frame configuration of FIG. 9. One skilled in the art will understand, the mechanism within the actuator 134 for converting a user's rotational motion into a cable pulling motion can be performed by various well known mechanical techniques, including: mechanical cam action having a latch.

The front frame legs 206 are connected together near the two front wheel assemblies 58 by a front cross member 248 (best shown in FIGS. 8 and 9). On each of the front frame legs 206 between the attachment of the cross member 248 and the corresponding front wheel assembly 58, there is a front frame connector 252 secured to the front frame leg 206. The pair of front frame connectors 252 (FIG. 8) pivotally connect a front frame member 256 to the pair of front frame legs 206. More precisely, the front frame member 256 includes a front upper cross member 260 which defines the upper front width of the cart 50, and a pair of side rods 264 that are pivotally connected to the front frame connectors 252. A pair of foldable spacers 268 (shown extended in FIG. 8, and shown folded in FIG. 9) are provided wherein each such spacer connects between a corresponding front frame leg 206 and a corresponding side rod 264. The spacers 268 are such that when unseated from their fully-extended semi-locked position of FIG. 8, the spacers 268 allow the front frame member 256 to easily pivot toward the front frame legs 206 so that the side rods 264 become substantially parallel to the front frame legs 206.

Referring now to the frame portions attached to the rear frame legs 174, a rear leg cross member assembly 272 (FIG. 8) includes an upper cross member 276, a lower cross member 280 and a pair of lower cross member connectors 284 that secure the lower cross member 280 to the rear frame legs 174. Note that in the present embodiment, the lower cross member 280 is curved downwardly when the cart 50 is in its fully-extended configuration and supported by its wheels 62 and 74. Such curving of the lower cross member 280 assists the user of the cart when needing to move the cart over an obstacle such as a curb. That is, the user can easily place his/her foot on the center portion of the lower cross member 280 and cause the front of the cart 50 to pivot toward the user on the rear wheels 74 so that the front wheels 62 no longer support the cart, and the front wheels can be lifted over or onto an obstacle such as a curb. Moreover, note that the lower cross member 280 may also include additional curves or appendages that provide the cart user with additional leverage for pivoting the cart on the rear wheels 74 to thereby place the front wheels 62 over or on an obstacle. In particular, a pedal or other appendage may be attached, e.g., to the central portion of the cross member 280 and project rearwardly (and possibly somewhat upwardly) from the cross member 280 so that the user may push down with his/her foot on the pedal and thereby cause the pivoting of the cart 50 on its rear wheels 74.

The frame 54 further includes a pair of pivoting leg supports 288 (FIGS. 3 and 8), wherein each such leg support is connected to the pair of front and rear frame legs on the same side of the cart 50. Moreover, the attachment of each of the leg supports 288 to its corresponding front frame leg 206 and rear frame leg 174 is provided in such a manner that the leg support 288 pivots relative to each of these frame legs to which it is connected. Thus, when the arm/leg hinge connector 198 is disconnected from the arm lock 216, and the front frame legs 206 pivot in the opposite rotational direction to arrow 228 (FIG. 11) then such motion is transmitted to the rear frame legs 174 by the attached leg supports 288. Thus, as the front frame legs 206 and the frame arms 158 pivotally fold together, the leg supports 288 cause the rear legs to also pivotally fold toward the frame arms 158 so that ultimately a fully-folded frame as in FIG. 9, is provided.

Note that once the frame 54 and/or the cart 50 is in its fully-folded position, a locking mechanism may be provided to secure the frame or cart in the folded configuration. It is within the scope of an embodiment of the folding cart that various mechanisms may be used to lock the frame (and more particularly the cart 50) in its folded configuration. In the embodiment shown in FIG. 8, a latch 292 is provided on the pivot rivet 178 so that the free end of the latch can be hooked around a latch shaft 296 projecting outwardly from one of the side rods 264 (FIG. 8). However, it is within the scope of the disclosed embodiment that other locking mechanisms may also be used to secure the cart 50 in its fully-folded configuration. For example, a latching mechanism may be provided on the arm lock 216 so that when the front frame legs 206 are fully-folded, such a latching mechanism latches into a corresponding portion of the arm lock 216 so that rotational movement of the cylinder 146 of the actuator 138 can also be used to move the arm lock 216, as previously described, for unlocking the cart from its fully-folded configuration. Alternatively, latches or other locks can be provided in other locations on the frame 54.

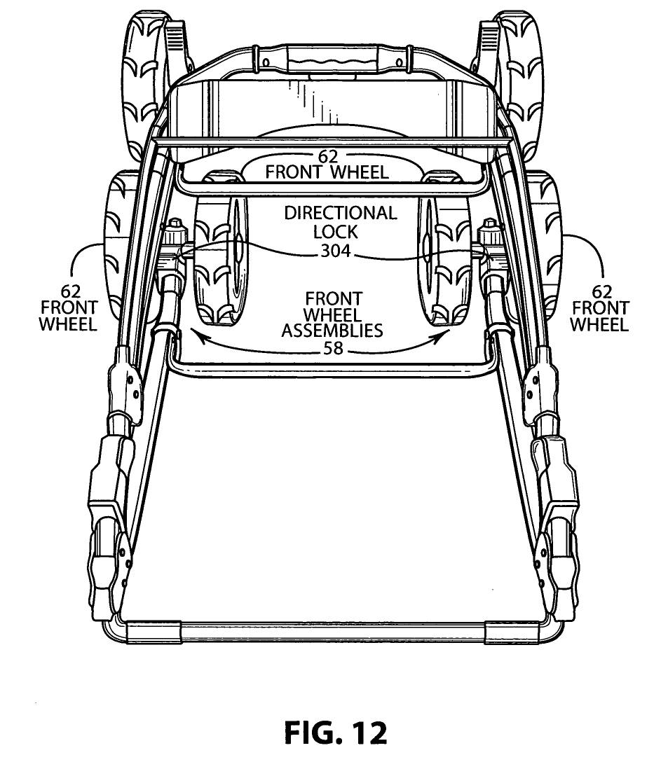

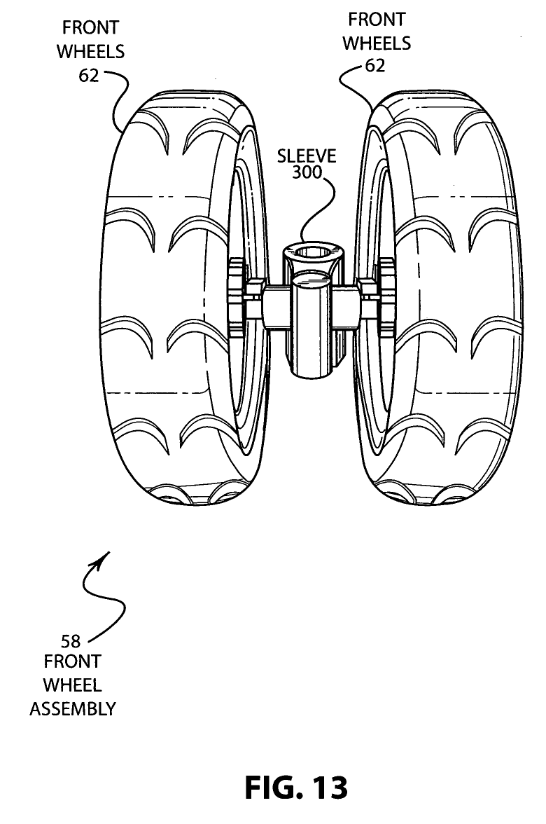

FIG. 12 shows the front side of the front wheel assemblies 58 with the frame in its folded position, and FIG. 13 shows the back side of a front wheel assembly 58. The front wheel assembly 58 have three distinguishing features. They are:
(1) each front wheel assembly 58 includes a pair of front wheels 62 wherein such paired wheels provide stability to the cart 50, and allow the cart to more easily be pushed over rough, uneven, and/or soft surfaces such as grass. Moreover, the size of the wheels 62 also contributes to more easily navigating the cart 50 over such non-smooth or soft surfaces in that a preferred outside diameter (i.e., height) of the wheels is in the range of 8 inches to 12 inches, and more preferably about 10 inches, and the width of the wheels 62 may vary in the range from 1½ to 2½ inches with a preferred width of approximately 2 inches;
(2) each wheel assembly 58 includes a sleeve 300 into which the free end of one of the front frame legs 206 is secured therein in a manner so that the wheel assembly can freely rotate about the portion of the front frame leg provided in the sleeve. Note however, that the sleeve 300 is offset from the axis of rotation for the wheel 62. Thus, when the cart 50 is pushed, this offset allows the wheels 62 to more readily follow the desired direction of the cart due to the decreased distance between the front wheels 62 and the rear wheels 74;
(3) as shown in FIG. 12, the front side of each of the wheel assemblies 58 includes a directional lock 304 which may be used to prevent the wheel assemblies 58 from pivoting about the portion of the front frame legs 206 secured within the sleeve 300. Accordingly, such directional locks can facilitate maintaining the cart 50 in a user desired stationary position.

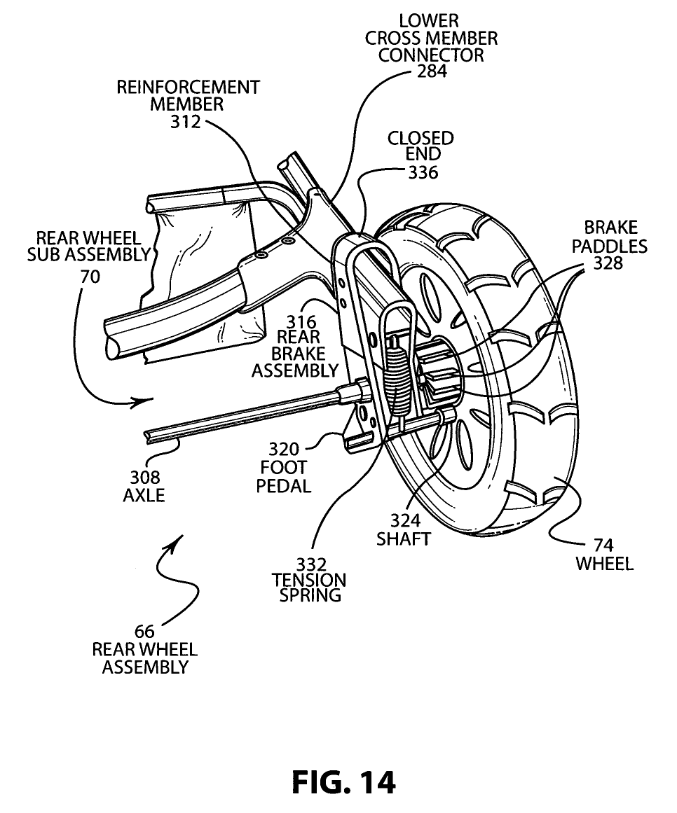

For further describing the rear wheel assembly 68, reference is made to FIGS. 3 and 14. In particular, the rear wheel assembly 66 includes two rear wheel subassemblies 70 that are connected together by an axle 308, wherein each of the rear wheel subassemblies 70 are mirror images of one another. FIG. 14 shows a more detailed view of one of the rear wheel subassemblies 70. Note that each rear wheel subassemblies 70 includes a U-shaped reinforcement member 312 that is secured to both a corresponding one of the cross member connectors 284, and the axle 308. In particular, note that the connector 284 extends through the U-shaped reinforcement member 312, wherein at least one bolt or rivet (more generally, shaft member) 316 extends through the sides of the reinforcement member 312 and the connector 284 positioned therebetween so that the member 312 can pivot on the shaft member 316.

Note that the U-shaped reinforcement member 312 also has attached thereto a rear brake assembly 316 that, in turn, includes a foot pedal 320 (also shown in FIG. 2) which is pivotally attached to the U-shaped reinforcement member 312 for moving the brake stop shaft 324 between: (a) a wheel locking position wherein the shaft 324 is positioned between brake paddles 328 that are uniformly positioned about the rear wheel axle 308 where the axle connects to the rear wheel 74, and (b) a second position (shown in FIG. 14) where the shaft 324 is positioned outside of the paddles 328. Accordingly, when the shaft 324 is disposed between the paddles 328 the wheel 74 is unable to move, and when the shaft 324 is positioned outside of the paddles 328 the wheel 74 can freely rotate.

FIG. 14 further shows a tension spring 332. This spring is attached to both the lower cross member connector 284 and its surrounding U-shaped reinforcement member 312 so that the spring acts as a shock absorber for the rear wheel assembly 66. That is, since the U-shaped reinforcement member 312 is able to pivot on the shaft member 316, and since the spring is connected at its opposite ends (via corresponding shafts) to the connector 284 and the open end of the U-shaped reinforcement member 312, the spring biases the closed end 336 of the U-shaped reinforcement member away from the end of the connector 284 where the spring is attached. Thus, when heavy loads are provided in the cart 50, the spring 332 will extend somewhat and the closed end 336 of the U-shaped reinforcement member will pivot on the shaft member 316 so that the closed end 336 moves towards the free end of the connector 284 having the spring attached thereto.

FIGS. 1-5 are particularly illustrative in showing the primary storage compartments of the foldable cart 50. However, it is important to note that the non rigid, flexible material 84 (foldable) from which the primary storage compartment(s) 82 is made is easily detachable and re-attachable to the frame 54. In particular, the storage compartment(s) 82 can be attached to the frame 54 via various mechanisms such as hook and loop fabrics (e.g., Velcro™), snaps, zippers, cords, hook and eye pairs, etc. will be attached to the front cross member 248 and the upper cross member 276. Moreover, for the frame embodiment of FIG. 8, it is intended that when the material 84 (which may include various fabrics) is properly attached on the frame 54 to thereby form the storage compartment(s) 82, the bottom of the primary storage compartment 82 will be attached to the front of the cross member 248 and the upper cross members 276. In one preferred embodiment, the attachment of the material 84 to these two cross members is performed by two extra flaps of material attached to the exterior of the bottom of the primary storage compartment(s) 82 so that each one of the flaps wraps around one of these cross members 248 and 276 and is secured around the cross member by a Velcro™ (more generally hook and loop) seam. Additionally, a similar front flap 340 is shown wrapped about the front upper cross member 260 in FIG. 1, wherein this flap is also secured about the front upper cross member with a Velcro™ seam. However, to further fix the position of the material 84 for the primary storage compartment(s) 82, Velcro™ hook fabrics may be secured onto the cross member 260 as identified by the instances of the labels 344 in FIG. 8. To complete the affixing of the material 84 onto the frame 54, a pair of Velcro™ straps may be sewn onto the material 84 in a position corresponding to the upper rear corner of the main compartment 82 (FIG. 2) when the cart is fully-extended. More particularly, such straps may be provided at substantially the corners of the main compartment 82 adjacent to the accessory attachment 120. Such straps may be affixed to the frame 54 by having the Velcro™ straps attach to mating hook material provided in a band within the upper arm portion 162. Such bands are shown in FIG. 8 and identified by the labels 348. Further note that preferably the dimensions of the main storage compartment 82 (as shown in the figures) are about 1 to about 1½ feet in width and 3 to 3½ feet in length. However, smaller or larger dimensions are within the scope of the disclosed embodiments.

The interior of the primary storage compartment(s) 82 may include one or more additional compartments for separating collections of items stored therein. In particular, assuming a single primary storage compartment 82, there may be one or more such additional compartments sown or otherwise attached to the interior walls of the primary storage compartment. In one embodiment, such additional compartments may occupy a substantial portion of the volume of the primary storage compartment 82. Further, such additional compartments may have rigid frames that may be removable or fold so that they do not affect the reduction in the size of the cart 50 when it is in its fully-folded configuration. In one embodiment, such additional compartments may be attached to, e.g., the interior front wall 86 such that the additional compartment has the appearance of being a backpack and provides the various subcompartments that are desirable on (and typical of) a backpack. In other embodiments, such additional compartments may be composed of a material substantially different from the material of the primary storage compartment 84. In particular, such additional compartments may be fabricated from a coarse mesh material so that items therein are easily identified through the mesh. Note that such coarse mesh compartments may be more acceptable to a merchant whose premises are entered by a user with an embodiment of the cart 50.

In particular, such a merchant may view the cart with less suspicion in that the contents of such additional compartments are readily identifiable. In another embodiment, one such additional compartment may be provided for a user's pet, e.g., a cat or small dog, so that the pet may accompany the user into shopping malls without the necessity of the user carrying the pet.

Various embodiments of the foldable cart 50 may also include one or more compartments attached to the exterior walls of the primary storage compartment 82 and/or to the exterior bottom of the main storage compartment. For example, in the embodiment of the cart 50 shown in the figures, there is a rear storage compartment 98 which may be of a size and shape for containing items such as a purse, briefcase, attache or laptop computer. Moreover, such compartments may be securely enclosed via Velcro™, zippers, snaps, a belt and buckle, or other closure means.

In operation, when the cart 50 is in its fully-folded configuration (FIGS. 4, and frame only, 9), the cart may be stored so that it is supported on the frame 54 (e.g., the front frame member 256) and the front wheel assemblies 58. In this position, the cart can be easily unfolded by first unlatching the frame fold latch 392 from the latch shaft 296, grasping the handle assembly 78 and pulling it in the direction of arrow 352. Accordingly, the handle assembly 78 separates from the rear wheel assembly 66, and the weight of the cart is relaxed from the front frame member 256 and the front wheel assemblies 58 so that the front frame legs 206 pivot relative to the frame arms 158, and ultimately lock together in the configuration of, e.g., FIG. 10. Accordingly, the cart 50 is substantially (or in some embodiments) entirely in its fully-extended or unfolded configure. At a minimum, the cart 50 is now fully functional, for being wheeled about on both its front and rear wheels by the user. However, at some point after locking the frame 54 in its extended position, the user may extend the member 256 by pivotally moving it so that the foldable spacers 268 are provided in the straight configuration as shown in, e.g., FIG. 8.

Alternatively, for folding the cart 50, the user presses the actuator button 142 (FIG. 3), rotates the cylinder 146 until the spring biased arm locks 216 cease to mate with their corresponding hinge connector 198 so that the user needs to only guide the substantially gravity-induced folding action of the cart into its fully-folded configuration, and then latch the 54 members together. In some embodiments of the folding cart, there may be an exterior additional compartment on the front wall 86 where such a compartment may store, e.g., a child's toys or other items that need not be frequently accessed while the cart is being moved. In still other embodiments, there may be an exterior compartment attached to the bottom of the main compartment 82, wherein such a compartment may be used for transporting larger items such as foldable chairs.

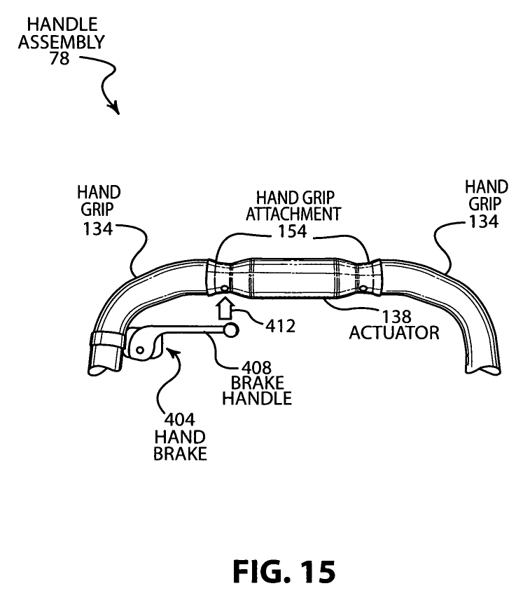

Various embodiments of the cart may also include other or alternative accessory attachments to the small item container 128 and the garment hanger 132 described hereinabove. For example, there may be hidden attachments or compartments for carrying extra money, spare keys, identification, etc. Further, an umbrella holder may be provided for holding a user's umbrella in its retracted position, e.g., attached to and substantially parallel to one of the frame arms 158. Additional attachments may be provided for securing an umbrella to the cart 50 with the umbrella are fully-extended. For example, the end shaft of a fully-extended umbrella may be secured within the accessory attachment 120 such that when the user pushes the cart 50, the extended umbrella protects the user in the presence of rain or intense sunlight. In other embodiments of the cart 50, an accessory attachment may be provided to hold a cane which the user may use when not using the cart for additional support. Still another attachment for the cart 50 may be an awning, retractable enclosure, tent, or cabana which can be extended when the cart 50 is stationary. In another embodiment of the folding cart, an extra oxygen tank attachment may be provided for elderly users wherein such an attachment may be provided, e.g., underneath the accessory attachment 120 so that the tank fits between the frame arms 158 and substantially underneath the accessory attachment 120. In other embodiments of the cart 50, a hand brake such as hand brake 404 (FIG. 15) may be included so that the cart is better able to be controlled when the user is proceeding down an inclined slope. In particular, such a hand brake 404 may control an additional braking mechanism provided on any of the wheels, wherein brake pads may contact the rim of each of the wheels in a manner similar to the brakes used on bicycles. Thus, the user can pull the brake handle 408 in the direction of arrow 412 to cause the brake (not shown) pads to, e.g., pinch the rim of any of the wheels.

In yet other embodiments of the folding cart, the cart 50 may include a clock that is, e.g., integral with the accessory attachment or the handle assembly 78. Similarly, a pedometer or a thermometer may also be included in the accessory attachment 120 or integral with the handle assembly 78. Moreover, embodiments of the cart 50 may further include reflectors or lights so that the cart is particularly useful after dark. In yet another embodiment of the cart 50 the wheels 62 and 74 may be substantially larger both in their diameter and width so that the cart could be easily pushed over sand such as at a beach. Accordingly, by making the dimensions of the cart somewhat larger than those recited hereinabove, such a cart may be configured as a “beach party” cart, wherein the interior of the main storage compartment 84 may be configured to securely store and transport tents, cabanas, volleyball nets, a keg(s) of beer, an ice chest(s), a music box, fire wood and other such items that would be desirable to transport over uneven, rocky or sandy surfaces.

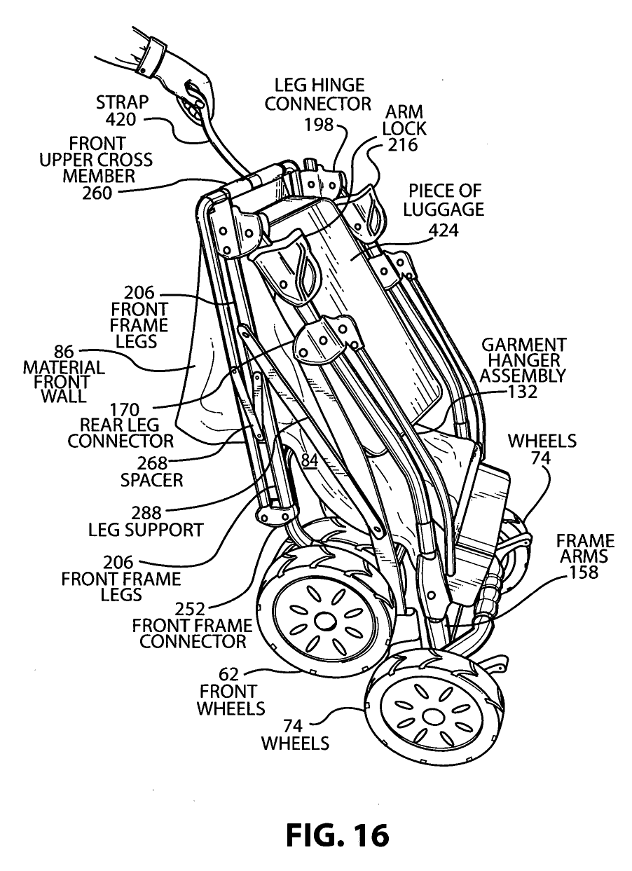

In yet another embodiment of the cart 50, the front upper cross member 260 may be provided with a handle 420 (FIG. 16) substantially near the center of its length. Accordingly, when the cart 50 is fully-folded and secured in this configuration by, e.g., the frame latch 292, the cart can be pulled from this handle 420 substantially behind the user wherein the cart rolls only on the rear wheels 74. Thus, the cart can be easily transported through a crowded area such as an airport without the necessity of fully-extending the cart. Moreover, when the cart is fully-folded, the material 84 forms a compartment within the frame 54 that is affective for carrying a backpack or luggage therein while the folded cart is pulled. Accordingly, FIG. 16 shows a piece of luggage 424 being transported in the folded cart 50.

In another embodiment of the cart 50, the cart may be folded into a sufficiently compact size to satisfy the dimensional restrictions for being carried board a commercial aircraft. In such an embodiment of the cart 50, the cross members of the frame 54 may telescope or fold, and there may be no rear axle 308. Additionally, the handle assembly 78 may only include the hand grips 134, wherein such hand grips do not connect, and wherein the actuator 138 is provided on one of the frame arms 158. Accordingly, the cable from such a re-positioned actuator 138 to the opposite frame arm 158 may be provided by exterior cabling substantially similar to that used for cables on bicycles. Accordingly, by using such methods as identified herein immediately above, an embodiment of the cart 50 may be folded so that its width is of a sufficient dimension to satisfy commercial aircraft constraints.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A foldable cart, comprising:
a foldable frame, including a first frame portion and a second frame portion that fold together;
a handle assembly connected to said first frame portion, wherein said handle assembly includes an actuator for folding said frame from an extended configuration to a folded configuration, wherein said actuator includes: (a) a safety locking component that must be unlocked prior to activating said actuator to fold said frame, and (b) a separation assembly for remotely separating said first frame portions and said second frame portion;
a flexible material attached to said frame for expanding at least one storage compartment when said frame is in said extended configuration, and for folding substantially within the dimensions of said frame when said frame is in said folded configuration;
a plurality of wheel assemblies attached to said frame and for supporting said cart when said frame is in said extended configuration, said wheel assemblies including: a first wheel assembly positioned at substantially a front of said cart when said frame is in said extended configuration, and a second wheel assembly positioned at substantially a rear of said cart when said frame is in said extended configuration;
wherein when said frame is actuated from said extended configuration to said folded configuration, said first wheel assembly and said second wheel assembly fold toward one another.

2. The cart of claim 1, wherein when said cart is in said folded configuration, said handle assembly folds toward at least one of said wheel assemblies.

3. The cart of claim 1, wherein said first frame portion and said second frame portion are pivotally connected to said handle assembly.

4. The cart of claim 1, wherein said a first frame portion provides attachment for at least one said first wheel assembly.

5. The cart of claim 4, wherein said first wheel assembly is pivotally attached to said first frame portion and is comprised of at least two coaxial wheels.

6. The cart of claim 1, wherein said a second frame portion provides attachment for at least one said second wheel assembly.

7. The cart of claim 6, wherein said second wheel assembly is pivotally attached to said second frame portion and is comprised of at least two coaxial wheels.

8. The cart of claim 1, wherein said actuator for folding said frame is actuated by twisting a hand grip on said handle assembly;

9. The cart of claim 1, wherein said actuator for folding said frame is locked from actuating by disengaging a locking member

10. The cart of claim 1, wherein said flexible material is fabric.

11. The cart of claim 10, wherein at least a portion of said fabric is comprised of a mesh material that allows items within said storage compartment to be visible through said mesh.

12. The cart of claim 1, wherein said storage compartment comprises a plurality of additional smaller storage compartments.

13. The cart of claim 1, further comprising:
an accessory attachment mounted on said handle assembly that is adapted to receive and store drinking cups.

14. The cart of claim 1, further comprising:
a wheel breaking mechanism that produces a restricting force on the rotation of at least one said wheel assembly.

15. The cart of claim 1, further comprising:
a garment hanger attachment connected to said foldable frame to receive garments on hangers for storage within said storage compartment.

16. A foldable cart, comprising:
a foldable frame, including a first frame portion and a second frame portion that fold together;
a handle assembly connected to said first frame portion, wherein said handle assembly includes an actuator for folding said frame from an extended configuration to a folded configuration, wherein said actuator includes a safety locking component that must be unlocked prior to activating said actuator to fold said frame, said frame that forms a plurality of attachment points that support a non-rigid material attached to said frame for expanding at least one storage compartment when said frame is in said extended configuration, and for folding substantially within the dimensions of said frame when said frame is in said folded configuration;
a plurality of wheel assemblies attached to said frame and for supporting said cart when said frame is in said extended configuration, said wheel assemblies including: a first wheel assembly positioned at substantially a front of said cart when said frame is in said extended configuration, and a second wheel assembly positioned at substantially a rear of said cart when said frame is in said extended configuration;
wherein when said frame is actuated from said extended configuration to said folded configuration, said first wheel assembly and said second wheel assembly fold toward one another.

17. The cart of claim 16, wherein when said cart is in said folded configuration, said handle assembly folds toward at least one of said wheel assemblies.

18. The cart of claim 16, wherein said first frame portion and said second frame portion are pivotally connected to said handle assembly.

19. The cart of claim 16, wherein said a first frame portion provides attachment for at least one said first wheel assembly.

20. The cart of claim 19, wherein said first wheel assembly is pivotally attached to said first frame portion and is comprised of at least two coaxial wheels.

21. The cart of claim 16, wherein said a second frame portion provides attachment for at least one said second wheel assembly.

22. The cart of claim 21, wherein said second wheel assembly is pivotally attached to said second frame portion and is comprised of at least two coaxial wheels.

23. The cart of claim 16, wherein said actuator for folding said frame is actuated by twisting a hand grip on said handle assembly;

24. The cart of claim 16, wherein said actuator for folding said frame is locked from actuating by disengaging a locking member

25. The cart of claim 16, wherein said flexible material is fabric.

26. The cart of claim 25, wherein at least a portion of said fabric is comprised of a mesh material that allows items within said storage compartment to be visible through said mesh.

27. The cart of claim 16, wherein said storage compartment comprises a plurality of additional smaller storage compartments.

28. The cart of claim 16, further comprising:
an accessory attachment mounted on said handle assembly that is adapted to receive and store drinking cups.

29. The cart of claim 16, further comprising:
a wheel breaking mechanism that produces a restricting force on the rotation of at least one said wheel assembly.

30. The cart of claim 16, further comprising:
a garment hanger attachment connected to said foldable frame to receive garments on hangers for storage within said storage compartment.
